(19) United States
(12) Patent Application Publication
(10) Pub. No.: US 2023/0036891 A1
(43) Pub. Date: Feb. 2, 2023

(54) VIDEO-BASED LEARNING ASSISTANCE METHOD AND APPARATUS

(71) Applicant: SHANGHAI BILIBILI TECHNOLOGY CO., LTD., Shanghai (CN)

(72) Inventors: Cheng CHEN, Shanghai (CN); Xiaoshan LIN, Shanghai (CN); Junjie LIN, Shanghai (CN)

(21) Appl. No.: 17/876,398

(22) Filed: Jul. 28, 2022

(30) Foreign Application Priority Data
Jul. 29, 2021 (CN) 202110865288.9

(51) Int. Cl. G09B 19/06; G09B 5/06

(52) U.S. Cl. CPC G09B 19/06; G09B 5/06

(57) ABSTRACT

The present application provides techniques of facilitating video-based language learning. The techniques comprise determining whether a target video is configured to support a learning mode for learning languages based on detecting an identifier indicative of the learning mode; displaying a learning mode control in response to determining that the target video supports the learning mode; receiving a learning instruction via the learning mode control; splitting into a first display area and a second display area in response to receiving the learning instruction, wherein the first display area is configured to display the target video, and the second display area is configured to display a learning toolbar and learning content corresponding to the target video; and displaying the learning toolbar and the learning content in the second display area while displaying the target video in the first display area.

### CROSS REFERENCE TO RELATED APPLICATION

The present application claims priority to Chinese Patent Application No. 202110865288.9, filed on Jul. 29, 2021, which is incorporated herein by reference in its entirety.

### BACKGROUND ART

Typically, it is one effective way to learn a related language by watching videos, for example, to learn English by watching an American TV series, to learn Japanese by watching a Japanese anime series, to learn Cantonese by watching a Hong Kong TV series, etc. However, at present, subtitles for videos can provide users only with basic translations for reference, which cannot help the users know well about the usage of slang expressions in the content or effectively learn some difficult words. In addition, users who know about the usage of related slang expressions or words cannot share their learning experience with other users. Therefore, a learning assistance method is urgently required to help users utilize videos better for language learning.

### SUMMARY OF THE INVENTION

In view of this, embodiments of the present application provide a video-based learning assistance method. The present application further relates to a video-based learning assistance apparatus, a computing device, and a computer-readable storage medium, so as to address a prior-art issue that a video platform is not suitable for learning and a user cannot learn easily and conveniently through videos.

According to a first aspect of the embodiments of the present application, there is provided a video-based learning assistance method, applied to a video player and including: when a target video is being played, receiving a learning instruction for the target video; in response to the learning instruction, playing the target video in a first display region of the video player, and presenting a learning toolbar corresponding to the target video in a second display region of the video player; and displaying learning content corresponding to the target video in the learning toolbar, where the learning content is related to subtitle information corresponding to the target video.

According to a second aspect of the embodiments of the present application, there is provided a video-based learning assistance apparatus, applied to a video player and including: a receiving module configured to: when a target video is being played, receive a learning instruction for the target video; a presentation module configured to: in response to the learning instruction, play the target video in a first display region of the video player, and present a learning toolbar corresponding to the target video in a second display region of the video player; and a display module configured to display learning content corresponding to the target video in the learning toolbar, where the learning content is related to subtitle information corresponding to the target video.

According to a third aspect of the embodiments of the present application, there is provided a computing device, including a memory, a processor, and computer instructions stored on the memory and executable on the processor, where when the processor executes the computer instructions, the steps of the video-based learning assistance method are implemented.

According to a fourth aspect of the embodiments of the present application, there is provided a computer-readable storage medium storing computer instructions, where when the computer instructions are executed by a processor, the steps of the video-based learning assistance method are implemented.

The video-based learning assistance method provided in the present application is applied to a video player and includes: when a target video is being played, receiving a learning instruction for the target video; in response to the learning instruction, playing the target video in a first display region of the video player, and presenting a learning toolbar corresponding to the target video in a second display region of the video player; and displaying learning content corresponding to the target video in the learning toolbar, where the learning content is related to subtitle information corresponding to the target video. According to an embodiment of the present application, a playback scenario and a learning scenario are combined based on requirements of a user for learning a language by watching videos; and learning content corresponding to a video being watched is displayed in a learning toolbar, which helps the user learn more easily and conveniently while watching the video content, thereby making learning enjoyable.

### BRIEF DESCRIPTION OF THE DRAWINGS

FIG. 1 is a flowchart of a video-based learning assistance method according to an embodiment of the present application;

FIG. 2 is a schematic diagram of an interface of a video player in a learning mode according to an embodiment of the present application;

FIG. 3 is a schematic diagram of an interface for a subtitle control of a video player according to an embodiment of the present application;

FIG. 4 is a schematic diagram of an interface for a vocabulary control of a video player according to an embodiment of the present application;

FIG. 5 is a schematic diagram of an interface for a vocabulary control of a video player according to another embodiment of the present application;

FIG. 6 is a schematic diagram of an annotation interface of a video player for sending a learning bullet-screen comment according to an embodiment of the present application;

FIG. 7 is a flowchart of processing of a video-based learning assistance method that is applied to a video L according to the present application;

FIG. 8 is a schematic diagram of a structure of a video-based learning assistance apparatus according to an embodiment of the present application; and

FIG. 9 is a block diagram of a structure of a computing device according to an embodiment of the present application.

### DETAILED DESCRIPTION OF EMBODIMENTS

In the following description, numerous specific details are set forth to provide a thorough understanding of the present application. However, the present application can be implemented in numerous other ways different from those described herein, and those skilled in the art can make similar extensions without departing from the essence of the present application. Therefore, the present application is not limited by the specific implementations disclosed below.

Terms used in one or more embodiments of the present application are merely to describe specific embodiments, and are not intended to limit one or more embodiments of the present application. The terms “a/an”, “said”, and “the” in the singular form used in one or more embodiments of the present application and the appended claims are also intended to include the plural form, unless otherwise clearly indicated in the context. It should also be understood that the term “and/or” used in one or more embodiments of the present application refers to and includes any or all possible combinations of one or more of the associated listed items.

It should be understood that although the terms “first”, “second”, etc. may be used in one or more embodiments of the present application to describe various information, the information should not be limited to these terms. These terms are merely used to distinguish the same type of information from one another. For example, without departing from the scope of one or more embodiments of the present application, “first” may also be referred to as “second”, and similarly, “second” may also be referred to as “first”. Depending on the context, the word “if” as used herein may be interpreted as “when” or “upon” or “in response to determining”.

First, the terms used in one or more embodiments of the present application are explained.

Treasure-box subtitles: a type of subtitles in a learning mode. A subtitle file is embedded in a function bar of a player, the subtitles can be dragged up or down to jump to a particular point in the playback progress, and definitions of key words in the subtitles and public notes taken by users can be viewed by clicking the subtitles.

Learning bullet-screen comments: a type of bullet-screen comments specific to the learning mode, including officially preset bullet-screen comments and user-created bullet-screen comments. The officially preset bullet-screen comments are generated by an administrator by making comparisons between high-frequency key words and a subtitle file of the content. The user-created bullet-screen comments are generated by users by sending real-time bullet-screen comments for words in the subtitles, so that the users can learn the related content.

Bullet-screen comments: comment information flying across the screen when users are watching an online video.

External subtitles: a subtitle file corresponding to a video that does not need to be embedded into the video, but only needs to be associated with the video.

For a long time, it has become one effective way to learn a related language by watching an American, British, Japanese, Korean, or Hong Kong TV series. However, only basic Chinese translations can be provided for lines in the TV series by using the current technologies of embedded or external subtitles, which cannot help users know more deeply about the usage of slang expressions, etc. in the content. Moreover, there are too many bullet-screen comments in a video, but few of them are useful for language learning and are difficult to filter, and therefore are not suitable to be used as a learning tool.

In view of this, in the present application, a video-based learning assistance method is provided. The present application further relates to a video-based learning assistance apparatus, a computing device, and a computer-readable storage medium, which are described in detail one by one in the following embodiments.

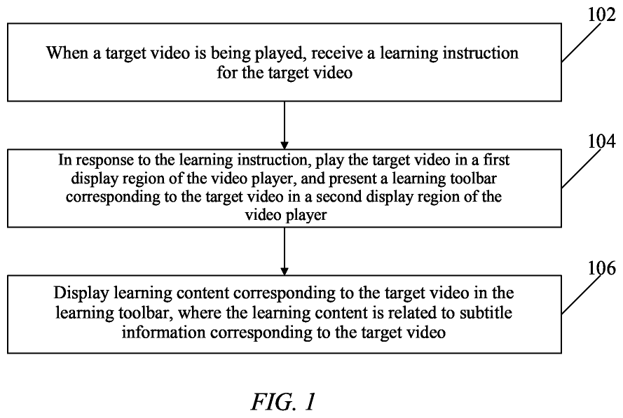

FIG. 1 is a flowchart of a video-based learning assistance method according to an embodiment of the present application. The method is applied to a video player, and specifically includes the following steps.

Step 102: When a target video is being played, receive a learning instruction for the target video.

The target video is specifically a video that is being played by a user. The learning instruction for the target video is a learning instruction issued by the user who wants to learn content in the target video. For example, the user is watching an American TV series L on a player, and when the user wants to learn Japanese with the Japanese TV series J, the user issues a learning instruction for the Japanese TV series J to the video player. In this case, the Japanese TV series J is the target video, and the video player receives the learning instruction for the Japanese TV series J.

In actual application, it is possible that a function of a learning mode is not available for all videos. An administrator needs to preprocess a video capable of the learning mode and add a corresponding identifier for a target video supporting the learning mode. Based on this, the receiving a learning instruction for the target video includes: if the target video supports a learning mode, presenting a learning mode control; and receiving the learning instruction issued by a user for the learning mode control.

The learning instruction for the target video can be received only after the administrator has added a corresponding identifier of the learning mode for the target video in advance. In actual application, whether the target video supports the learning mode, that is, whether the target video has the identifier of the learning mode, needs to be determined first. If the target video does not have the identifier of the learning mode, the learning instruction for the target video cannot be received. If the target video has the identifier of the learning mode, that is, the target video supports the learning mode, the learning mode control is displayed in the video player. The learning mode control provides an entry into the learning mode, and the user may click the learning mode control to send the learning instruction to the video player. In this case, the video player receives the learning instruction from the user for the learning mode control.

In a specific implementation provided in the present application, for example, the user is watching an American TV series L on a video player. The American TV series L is the target video. The player detects whether the American TV series L has a corresponding identifier of the learning mode. If it is detected that the American TV series L has the identifier of the learning mode, it is determined that the American TV series L supports the learning mode, and then the learning mode control is presented. In the process of watching the American TV series L, if the user wants to learn English with the American TV series L, the user may click the learning mode control to send a learning instruction for the American TV series L to the video player.

Step 104: In response to the learning instruction, play the target video in a first display region of the video player, and present a learning toolbar corresponding to the target video in a second display region of the video player.

After receiving the learning instruction for the target video, the video player is divided into the first display region and the second display region in response to the learning instruction. In the first display region, the target video is scaled down according to a preset ratio and played in the first display region. In the second display region, the learning toolbar for learning with the target video is presented, and the user can learn by using the learning toolbar.

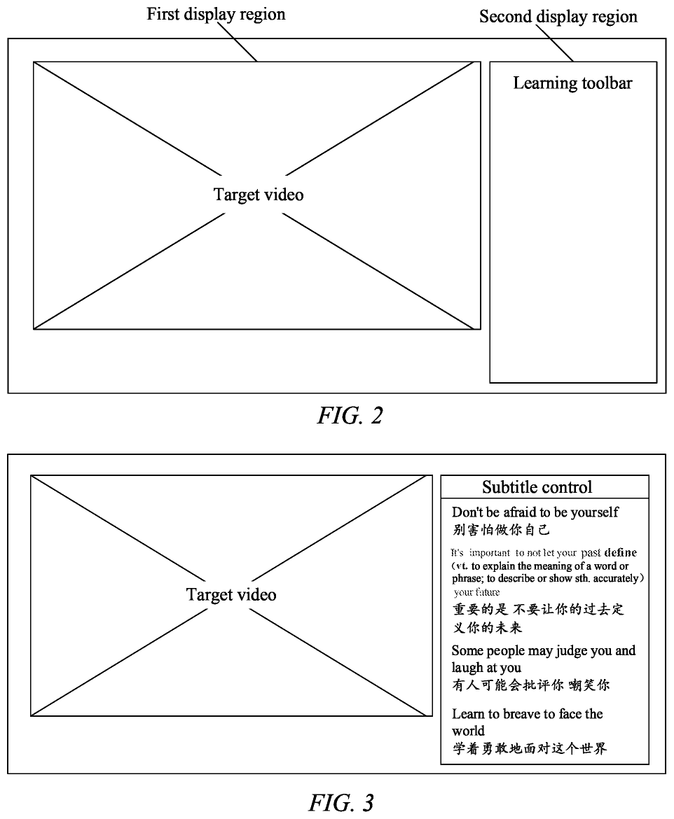

Referring to FIG. 2, FIG. 2 is a schematic diagram of an interface of a video player in a learning mode according to an embodiment of the present application. As shown in FIG. 2, the first display region is on the left of the player, and the second display region is on the right of the player. Further, the target video is played in the first display region, and the learning toolbar corresponding to the target video is presented in the second display region. It should be noted that FIG. 2 shows merely a specific implementation of the video player in the learning mode. In actual application, specific positions and presentation forms of the first display region and the second display region are not limited. Alternatively, the first display region and the second display region may be arranged in a top-down manner or the like. In the present application, information about the specific positions of the first presentation region and the second presentation region is not limited and is subject to actual application.

In a specific implementation provided in the present application, still in the foregoing example, the user is watching the American TV series L on the video player, and issues the learning instruction for the American TV series L to the video player. The video player scales down the American TV series L according to the preset ratio and then displays the American TV series L in the first display region on the left of the screen for continued playback. At the same time, the learning toolbar for the American TV series L is displayed in the second display region on the right of the screen.

Step 106: Display learning content corresponding to the target video in the learning toolbar, where the learning content is related to subtitle information corresponding to the target video.

The learning toolbar is a toolbar for the user to learn based on the target video.

Specific learning content corresponding to the target video is presented in the learning toolbar.

Specifically, the learning toolbar includes a subtitle control.

The displaying learning content corresponding to the target video in the learning toolbar includes: displaying, in the subtitle control, a list of subtitle information for the target video, where the subtitle information of the target video is presented in the list of subtitle information.

Referring to FIG. 3, FIG. 3 is a schematic diagram of an interface for a subtitle control of a video player according to an embodiment of the present application. There is the subtitle control, namely the treasure-box subtitles, in the learning toolbar. The list of subtitle information for the target video is displayed in response to selecting the subtitle control, and subtitles in the list of subtitle information scroll automatically with the playback of the target video. Both Chinese and English subtitles for the target video are displayed in a subtitle list. In another specific implementation provided in the present application, subtitle information in the list of subtitle information may further include information about a concise definition of a word or phrase. As shown in FIG. 3, in the sentence “It's important to not let your past define (vt. to explain the meaning of a word or phrase, to describe or show something accurately) your future”, information about a concise definition of “define” in the current sentence follows the word “define”. The user may obtain a Chinese translation of the current line from the list of subtitle information, and may further determine a concise definition of a key word. It should be noted that a concise definition of each word or phrase is preconfigured by the administrator for the word or phrase.

To display the list of subtitle information in the subtitle control, the list of subtitle information needs to be obtained. Therefore, the method further includes: obtaining the list of subtitle information preset for the target video; or obtaining audio data of the target video, and recognizing the audio data to generate the list of subtitle information.

Specifically, the list of subtitle information may be a subtitle file preset for the target video. In some cases, there is no subtitle available for the target video. Further, the audio data of the target video may be obtained, and the audio data is recognized by means of AI audio recognition to generate a corresponding list of subtitle information.

The list of subtitle information may be in the form of external subtitles. The user may choose to show or hide the list of subtitle information. When the user chooses to show the list of subtitle information, the user can view the list of subtitle information for reference while listening to audio in the video. When the user chooses to hide the list of subtitle information, the user can simply practice listening.

In actual application, the user usually listens to a conversation repeatedly when practicing listening by watching a video. If this is implemented by dragging a progress bar for the video each time, there is a waste of time because it is impossible to drag it to the exact corresponding time point on the progress bar. In view of this, the method provided in the present application further includes: receiving a subtitle drag instruction for the list of subtitle information; determining, based on the subtitle drag instruction, a subtitle to be played; and determining a drag playback time point for the target video based on the subtitle to be played, and playing the target video from the drag playback time point.

When the user wants to watch a segment of the video repeatedly, the user can make it by dragging a subtitle in the list of subtitle information. In other words, the user may drag the subtitle in the list of subtitle information until the segment that the user wants to watch, that is, the user issues the subtitle drag instruction to the video player. After receiving the subtitle drag instruction for the list of subtitle information, the video player scrolls the list of subtitle information until a position desired by the user, and then determines a corresponding subtitle as the subtitle to be played. There is a fixed playback time period for each subtitle in the video. Therefore, a starting time of the subtitle to be played is used as the drag playback time for the target video. In other words, the drag playback time is the starting time of the subtitle to be played. After the drag playback time point for the target video is determined, the target video can be played from the drag playback time point.

In a specific implementation provided in the present application, for example, the user wants to practice listening by watching a conversation in a video V repeatedly. The user drags the list of subtitle information to a subtitle that the user wants to play, and the subtitle to be played is determined. If a playback time interval for the subtitle to be played in the video is “00:01:30 to 00:01:35”, the drag playback time point is determined as 00:01:30, and the subtitle starts to be played from 00:01:30 of the video V.

The user can jump to a particular point in the progress with precision by scrolling the list of subtitle information and dragging the subtitle to a desired playback starting time, thereby reducing an adjustment time of the user and making it convenient for the user to watch a segment of the video repeatedly. In addition, key words in the subtitles may be processed in a corresponding special manner, for example, highlighted in bold or in red, added with concise definitions, or other operations, to help the user obtain information about a related word directly for easy learning.

In another specific scenario provided in the present application, when the user finds a specially annotated word or phrase in a subtitle in the list of subtitle information and wants to learn and know more about the word or phrase, the user may further learn specific content of the related word in the learning toolbar.

Specifically, the learning toolbar includes a vocabulary control.

The method further includes S1082 and S1084.

S1082: Determine a target subtitle, and determine a target word in the target subtitle.

The target subtitle is a subtitle that the user determines to learn, and obtaining the target subtitle includes: receiving a vocabulary learning instruction for the list of subtitle information for the target video, and determining the target subtitle based on the vocabulary learning instruction; or obtaining the target subtitle in a current video frame of the target video.

When the user views subtitle information in the list of subtitle information and finds that a specially annotated word or phrase in the subtitle information is not so familiar and needs to be further learned, the user may issue the vocabulary learning instruction for the list of subtitle information. The video editor may receive the vocabulary learning instruction for the list of subtitle information issued by the user. Subtitle information to which the vocabulary learning instruction is directed is the target subtitle. For example, five pieces of subtitle information are displayed in the list of subtitle information, and if the user wants to learn a word in the second piece of subtitle information, the vocabulary learning instruction is issued for the second subtitle in the list of subtitle information. The vocabulary learning instruction corresponds to the second subtitle, and the second subtitle is the target subtitle.

In another specific implementation scenario provided in the present application, alternatively, a subtitle in a current video frame that is being watched by the user in the process of watching the video may be used as the target subtitle.

A specially annotated word in the target subtitle is the target word. In actual application, there may be one target word, two target words, or more than two target words in the target subtitle. In the present application, the number of target words is not limited and is subject to actual application. The target word may be a high-frequency word, a key word in a language proficiency test, a rarely used word, a slang expression, etc. Specific content of the target word is not limited, either, in the present application.

In a specific implementation provided in the present application, still in the foregoing example. When the user wants to learn and know more about the word “define” in the subtitle “It's important to not let your past define (vt. to explain the meaning of a word or phrase, to describe or show something accurately) your future”, the user may click the subtitle. In this case, this subtitle is the target subtitle, and “define” in this target subtitle is the target word.

S1084: Obtain preset word information and/or customized word information for the target word, and display the preset word information and/or the customized word information in the vocabulary control.

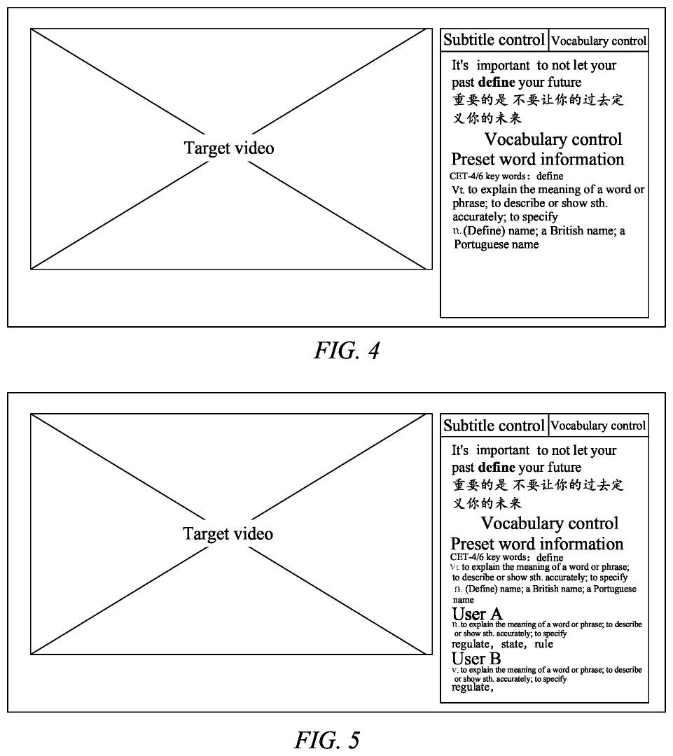

The preset word information for the target word is specifically officially preset information about the word. For example, preset word information officially preset for the word “define” is “CET-4/6 key words: Vt: to explain the meaning of a word or phrase, to describe or show something accurately, to specify; n.(Define) namer: British name; Portuguese name.” The preset word information for the word may be displayed in the vocabulary control. Referring to FIG. 4, FIG. 4 is a schematic diagram of an interface for a vocabulary control of a video player according to an embodiment of the present application. FIG. 4 shows the preset word information for “define”.

There are many sources of the preset word information, and therefore, the obtaining the preset word information for the target word includes: obtaining the preset word information for the target word through a third-party dictionary interface; or obtaining the preset word information predefined for the target word.

Preset word information for each word or phrase can be obtained by means of screen word-fetching through the third-party dictionary interface. Alternatively, the administrator may input preset word information for some key words to a vocabulary bank in advance, and the preset word information for each target word may be obtained from the vocabulary bank. The key words may be daily high-frequency words, high-frequency words in a language proficiency test, slang expressions used in daily life, etc. This is not limited in the present application.

In actual application, the preset word information for the target word may be sometimes inaccurate. For example, for a slang expression used in daily life, some users may have a more profound understanding when they have a local life experience, and they may find the preset word information inaccurate when watching a video. Alternatively, some other users may want to provide more information related to the target word, for example, its commonly confused words, synonyms, and associated words, which cannot be provided in the preset word information. Based on this, the customized word information corresponding to the target word may further be obtained. The customized word information is word information related to the target word and annotated freely by the user, for example, the usage of a slang expression, a correct definition, a synonym, and a commonly confused word, or an associated word. The preset word information and the customized word information for the target word may be displayed in the vocabulary control. Referring to FIG. 5, FIG. 5 is a schematic diagram of an interface for a vocabulary control of a video player according to another embodiment of the present application. As shown in FIG. 5, in addition to the preset word information, customized word information sent by a user A and a user B is also displayed in the vocabulary control, which helps other users gather advice from different users in the vocabulary control, thereby facilitating learning and understanding the definition and usage of a word and improving user experience.

A source of the customized word information is usually a learning comment sent by a user. The learning comment comprises customized word information associated with the target word. A learning bullet screen may be generated based on the learning comment. A learning bullet screen may be displayed in an overlay above the video. For example, the learning bullet screen may be shown moving across video frames, such as scrolling (e.g., from right to left, left to right, top to bottom, bottom to top) across the video frames. In some embodiments, bullet screens may be text bullet screens comprising comment content sent by users. A user may share the customized word information associated with the target word with other users by sending a learning comment. Based on this, the method further includes: receiving a learning comment from a user, where the customized word information for the target word is carried in the learning comment.

The learning comment is comment information sent by the user, and the customized word information for the target word is carried in the learning comment. In actual application, the receiving a learning comment includes: receiving a learning comment sending instruction; in response to the learning comment sending instruction, presenting an annotation interface for the target word; and collecting the customized word information for the target word that a user enters in the annotation interface.

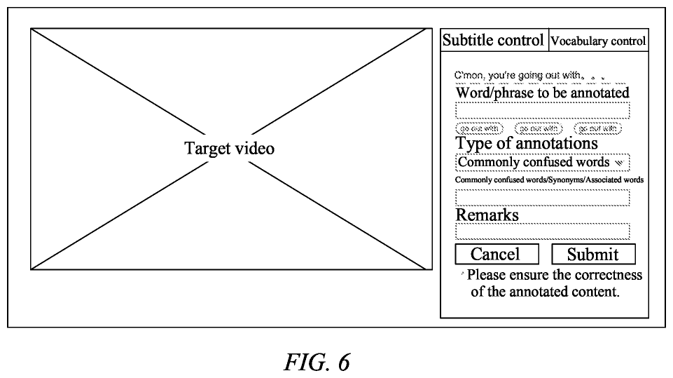

The learning comment is different from a non-learning comment and needs to be academic to some degree. Therefore, the learning comment needs to conform to some corresponding formats. The user may click a comment sending button in the learning mode to issue the learning comment sending instruction. The video player receives the learning comment sending instruction, and in response to the learning comment sending instruction, presents the annotation interface for the target word. Referring to FIG. 6, FIG. 6 is a schematic diagram of an annotation interface of a video player displayed in response to receiving a learning comment sending instruction according to an embodiment of the present application. As shown in FIG. 6, after the learning comment sending button is clicked in the learning mode, the video player may enter the annotation interface for the target word. The user may enter the customized word information for the target word in the annotation interface, and click a submit edit button to send the learning comment. The editor can receive the learning comment. A learning bullet screen may be generated based on the learning comment, and the learning bullet screen comprises the customized word information associated with the target word.

Both learning bullet screens and non-learning bullet screens can be properly displayed in the target video, e.g., moving across one or more frames of the target video. Different from the non-learning bullet screens, a time point for playing the learning bullet screen needs to be associated with the corresponding target subtitle. To be specific, the learning bullet screen needs to be displayed within a corresponding time period of playing the target subtitle in the target video, to help the user learn corresponding word information based on the target subtitle. Based on this, the method further includes: determining a playback time period for playing the target subtitle in the target video; determining a bullet-screen time point in the playback time period; and presenting the learning bullet screen for the target word at the bullet-screen time point, and the learning bullet screen is generated based on a learning comment sent by a user and comprises the customized word information associated with the target word.

After the edit is submitted in the word annotation interface, a playback time interval for the target subtitle corresponding to the target word in the target video needs to be determined, that is, a time interval in which the target word is to be presented in the target video needs to be determined. Then, a bullet-screen time point for the learning bullet screen may be selected randomly from the playback time interval as a time point for presenting the learning bullet screen. Further, the learning bullet screen corresponding to the target word is generated based on the customized word information corresponding to the target word. The learning bullet screen corresponding to the target word is presented when the target video is played to the bullet-screen comment time point.

The learning bullet-screen comment(s) and the non-learning bullet screen(s) can be stored together in a bullet-screen pool for the target video and presented together. For differentiation in presentation, the learning bullet screen(s) and the non-learning bullet screens may be presented in different forms. In addition, to improve learning efficiency of the user, a specific learning bullet screen switch may further be provided, so that the learning bullet screen can be presented alone, with the non-learning bullet screens being blocked, thereby improving user experience. In another specific implementation provided in the present application, alternatively, only the learning bullet screen(s) may be presented in the learning mode, thereby improving learning efficiency of the user. The foregoing description is merely a schematic description of the presentation manners of the learning bullet screen(s) and the non-learning bullet screen(s) in the present application. In actual application, there may be a plurality of presentation forms, to distinguish the learning bullet screen(s) from the non-learning bullet screen(s). This is not limited in the present application.

In actual application, when the user may not be able to understand or remember a word or phrase quickly, in order not to delay the progress, the user may further add the word or phrase to a learning note for subsequent review. Based on this, the method further includes: receiving a note-taking instruction for the target word; and in response to the note-taking instruction, adding the target word to a learning notebook.

The note-taking instruction issued by the user for the target word is received, and in response to the note-taking instruction, the target word is added to the learning notebook. In the learning notebook, corresponding preset word information and customized word information may be associated with the target word. After watching the whole target video, the user can review the word in the target video from the learning notebook, thereby improving learning experience of the user.

The video-based learning assistance method provided in the embodiments of the present application is applied to a video player and includes: when a target video is being played, receiving a learning instruction for the target video; in response to the learning instruction, playing the target video in a first display region of the video player, and presenting a learning toolbar corresponding to the target video in a second display region of the video player; and displaying learning content corresponding to the target video in the learning toolbar, where the learning content is related to subtitle information corresponding to the target video. A playback scenario and a learning scenario are combined based on requirements of a user for learning a language by watching videos; and learning content corresponding to a video being watched is displayed in a learning toolbar, which helps the user learn more easily and conveniently while watching the video content, thereby making learning enjoyable.

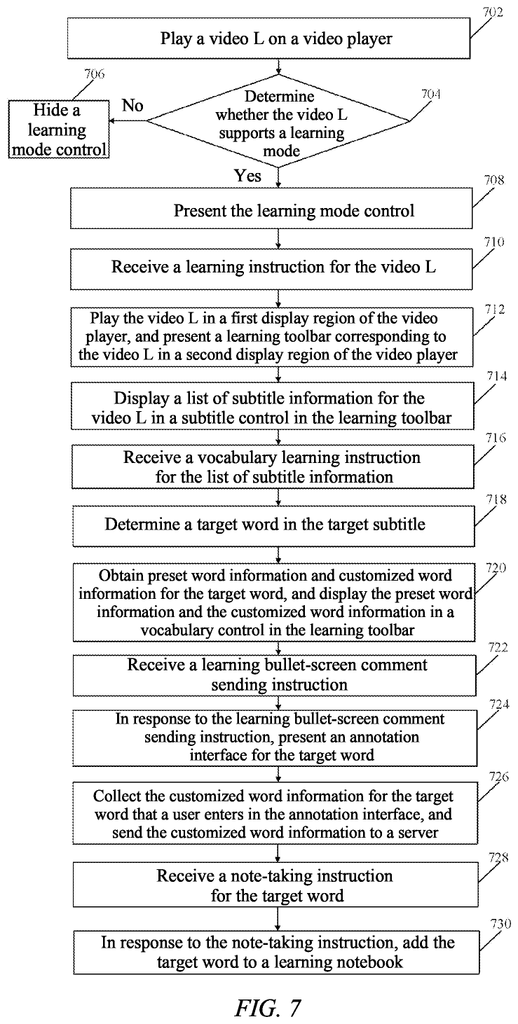

The video-based learning assistance method is further described below with reference to FIG. 7 by using an example in which the video-based learning assistance method provided in the present application is applied to a video L. FIG. 7 is a flowchart of processing of a video-based learning assistance method that is applied to a video L according to an embodiment of the present application. The method specifically includes the following steps.

Step 702: Display the video L on a video player.

In a specific embodiment provided in the present application, a user watches the video L on the video player.

Step 704: Determine whether the video L supports a learning mode. If no, step 706 is performed; and if yes, step 708 is performed.

In a specific embodiment provided in the present application, still in the foregoing example, the video player determines whether the video L has an identifier of the learning mode, that is, determines whether the video L supports the learning mode. If no, step 706 is performed; and if yes, step 708 is performed.

Step 706: Hide a learning mode control.

In a specific embodiment provided in the present application, still in the foregoing example, if the video L does not support the learning mode, the learning mode control is hidden.

Step 708: Present the learning mode control.

In a specific embodiment provided in the present application, still in the foregoing example, if the video L supports the learning mode, the learning mode control is presented, to provide an entry into the learning mode.

Step 710: Receive a learning instruction for the video L.

In a specific embodiment provided in the present application, still in the foregoing example, the user clicks the presented learning mode control, and issues the learning instruction for the video L; and the video player receives the learning instruction.

Step 712: Play the video L in a first display region of the video player, and present a learning toolbar corresponding to the video L in a second display region of the video player.

In a specific embodiment provided in the present application, still in the foregoing example, after the learning instruction is received, the video L is played in the first display region of the video player, and the learning toolbar is presented in the second display region. Learning content of the video L is presented in the learning toolbar.

Step 714: Display a list of subtitle information for the video L in a subtitle control in the learning toolbar.

In a specific embodiment provided in the present application, still in the foregoing example, there is the subtitle control in the learning toolbar, and there is the list of subtitle information for the video L in the subtitle control. Subtitle information scrolls with the playback of the video L. The user may scroll up and down the list of subtitle information to control the playback of the video L, and can quickly locate an actual playback point corresponding to a specific subtitle, thereby helping the user watch a segment of the video repeatedly.

Step 716: Receive a vocabulary learning instruction for the list of subtitle information.

In a specific embodiment provided in the present application, still in the foregoing example, the vocabulary learning instruction issued by the user for the list of subtitle information may further be received, so that the usage of a specific word or phrase in the subtitle can be further learned.

Step 718: Determine a target word in the target subtitle.

In a specific embodiment provided in the present application, still in the foregoing example, a specific subtitle to which the vocabulary learning instruction is directed is the target subtitle, and the target word in the target subtitle is further determined.

Step 720: Obtain preset word information and customized word information for the target word, and display the preset word information and the customized word information in a vocabulary control in the learning toolbar.

In a specific embodiment provided in the present application, still in the foregoing example, the preset word information and the customized word information for the target word are obtained, and the preset word information and the customized word information for the target word are displayed in the vocabulary control in the learning toolbar, thereby helping the user learn more deeply learning content related to the target word. User experience is improved.

Step 722: Receive a learning bullet-screen comment sending instruction.

In a specific embodiment provided in the present application, still in the foregoing example, when a user has an understanding or idea about the target word, the user may send the learning bullet-screen comment sending instruction, and the video player receives the learning bullet-screen comment sending instruction.

Step 724: In response to the learning bullet-screen comment sending instruction, present an annotation interface for the target word.

In a specific embodiment provided in the present application, still in the foregoing example, in response to the learning bullet-screen comment sending instruction, the annotation interface corresponding to the target word is presented, thereby helping the user enter content related to the target word in the annotation interface.

Step 726: Collect the customized word information for the target word that the user enters in the annotation interface, and send the customized word information to a server.

In a specific embodiment provided in the present application, still in the foregoing example, a mobile phone user enters the information in the annotation interface, and the customized word information for the target word is generated. Then, the customized word information is sent to the server. Different users may jointly create more information for the same target word to form a better database, thereby effectively helping other users know further the content related to the target word.

Step 728: Receive a note-taking instruction for the target word.

In a specific embodiment provided in the present application, still in the foregoing example, if the user wants to add the target word to the learning note of the user, the user sends the note-taking instruction for the target word, and the video editor receives the note-taking instruction.

Step 730: In response to the note-taking instruction, adding the target word to a learning notebook.

In a specific embodiment provided in the present application, still in the foregoing example, the target word is added to the learning notebook of the user according to the note-taking instruction, which helps the user review the target word in subsequent learning, thereby enhancing learning experience.

The video-based learning assistance method provided in the embodiments of the present application is applied to a video player and includes: when a target video is being played, receiving a learning instruction for the target video; in response to the learning instruction, playing the target video in a first display region of the video player, and presenting a learning toolbar corresponding to the target video in a second display region of the video player; and displaying learning content corresponding to the target video in the learning toolbar, where the learning content is related to subtitle information corresponding to the target video. A playback scenario and a learning scenario are combined based on requirements of a user for learning a language by watching videos; and learning content corresponding to a video being watched is displayed in a learning toolbar, which helps the user learn more easily and conveniently while watching the video content, thereby making learning enjoyable.

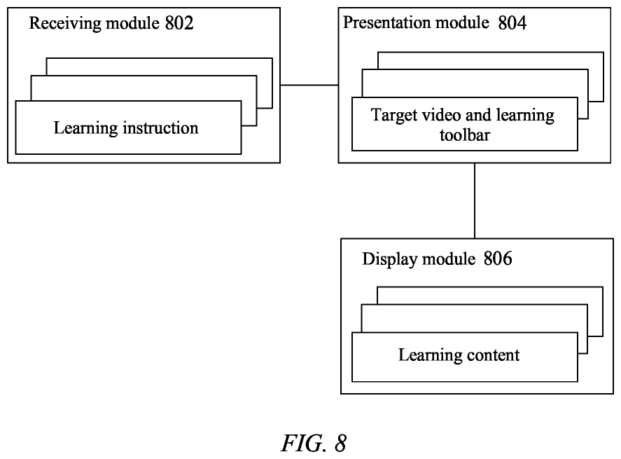

Corresponding to the foregoing embodiments of the video-based learning assistance method, the present application further provides an embodiment of a video-based learning assistance apparatus. FIG. 8 is a schematic diagram of a structure of a video-based learning assistance apparatus according to an embodiment of the present application. As shown in FIG. 8, the apparatus includes: a receiving module 802 configured to: when a target video is being played, receive a learning instruction for the target video; a presentation module 804 configured to: in response to the learning instruction, play the target video in a first display region of the video player, and present a learning toolbar corresponding to the target video in a second display region of the video player; and a display module 806 configured to display learning content corresponding to the target video in the learning toolbar, where the learning content is related to subtitle information corresponding to the target video.

Optionally, the learning toolbar includes a subtitle control.

The display module 806 is further configured to: display, in the subtitle control, a list of subtitle information for the target video, where the subtitle information of the target video is presented in the list of subtitle information.

The display module 806 is further configured to: obtain the list of subtitle information preset for the target video; or obtain audio data of the target video, and recognize the audio data to generate the list of subtitle information.

Optionally, the apparatus further includes: a subtitle drag instruction receiving module configured to receive a subtitle drag instruction for the list of subtitle information; a subtitle determination module configured to determine, based on the subtitle drag instruction, a subtitle to be played; and a playback module configured to: determine a drag playback time point for the target video based on the subtitle to be played, and play the target video from the drag playback time point.

Optionally, the learning toolbar includes a vocabulary control.

The apparatus further includes: a word determination module configured to: determine a target subtitle, and determine a target word in the target subtitle; and a word information obtaining module configured to: obtain preset word information and/or customized word information for the target word, and display the preset word information and/or the customized word information in the vocabulary control.

Optionally, the word determination module is further configured to: receive a vocabulary learning instruction for the list of subtitle information for the target video, and determine the target subtitle based on the vocabulary learning instruction; or obtain the target subtitle in a current video frame of the target video.

Optionally, the word information obtaining module is further configured to: obtain the preset word information for the target word through a third-party dictionary interface; or obtain the preset word information predefined for the target word.

Optionally, the apparatus further includes: a learning bullet-screen comment receiving module configured to receive a learning bullet-screen comment, where the customized word information for the target word is carried in the learning bullet-screen comment.

Optionally, the apparatus further includes: a playback time interval determination module configured to determine a playback time interval for the target subtitle in the target video; a bullet-screen comment time point determination module configured to determine a bullet-screen comment time point in the playback time interval; a learning bullet-screen comment generation module configured to generate a learning bullet-screen comment for the target word based on the target word and the customized word information for the target word; and a learning bullet-screen comment presentation module configured to present the learning bullet-screen comment for the target word at the bullet-screen comment time point.

Optionally, the learning bullet-screen comment receiving module is further configured to: receive a learning comment sending instruction; in response to the learning comment sending instruction, present an annotation interface for the target word; and collect the customized word information for the target word that a user enters in the annotation interface.

Optionally, the apparatus further includes: a note-taking instruction receiving module configured to receive a note-taking instruction for the target word; and a word adding module configured to: in response to the note-taking instruction, add the target word to a learning notebook.

Optionally, the receiving module 802 is further configured to: if the target video supports a learning mode, present a learning mode control; and receive the learning instruction issued by a user for the learning mode control.

The video-based learning assistance apparatus provided in the embodiments of the present application is applied to a video player and includes: when a target video is being played, receiving a learning instruction for the target video; in response to the learning instruction, playing the target video in a first display region of the video player, and presenting a learning toolbar corresponding to the target video in a second display region of the video player; and displaying learning content corresponding to the target video in the learning toolbar, where the learning content is related to subtitle information corresponding to the target video. A playback scenario and a learning scenario are combined based on requirements of a user for learning a language by watching videos; and learning content corresponding to a video being watched is displayed in a learning toolbar, which helps the user learn more easily and conveniently while watching the video content, thereby making learning enjoyable.

The foregoing description is a schematic solution of the video-based learning assistance apparatus in the embodiments. It should be noted that the technical solution of the video-based learning assistance apparatus belongs to the same concept as the technical solution of the foregoing video-based learning assistance method. For the details that are not further described in the technical solution of the video-based learning assistance apparatus, reference may be made to the description of the technical solution of the foregoing video-based learning assistance method.

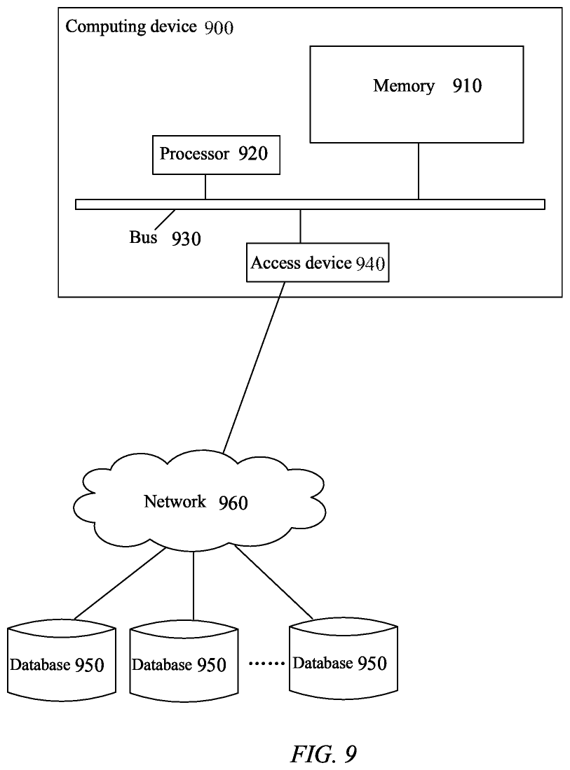

FIG. 9 is a block diagram of a structure of a computing device 900 according to an embodiment of the present application. Components of the computing device 900 include, but are not limited to, a memory 910 and a processor 920. The processor 920 is connected to the memory 910 through a bus 930, and a database 950 is configured to store data.

The computing device 900 further includes an access device 940. The access device 940 enables communication of the computing device 900 via one or more networks 960. Examples of the networks include a public switched telephone network (PSTN), a local area network (LAN), a wide area network (WAN), a personal area network (PAN), or a combination of communication networks such as the Internet. The access device 940 may include one or more of any types of wired or wireless network interfaces (e.g., a network interface card (NIC)), such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near-field communication (NFC) interface.

In an embodiment of the present application, the foregoing components of the computing device 900 and other components not shown in FIG. 9 may also be connected to each other, for example, through a bus. It should be understood that the block diagram of the structure of the computing device shown in FIG. 9 is merely an example, instead of a limitation on the scope of the present application. Those skilled in the art can add or replace other components as required.

The computing device 900 may be any type of stationary or mobile computing device, including a mobile computer or a mobile computing device (e.g., a tablet computer, a personal digital assistant, a laptop computer, a notebook computer, a netbook, etc.), a mobile phone (e.g., a smartphone), a wearable computing device (e.g., a smart watch, smart glasses, etc.), or other types of mobile devices, or a stationary computing device such as a desktop computer or a PC. The computing device 900 may alternatively be a mobile or stationary server.

When the processor 920 executes the computer instructions, the steps of the video-based learning assistance method are implemented.

The foregoing description is a schematic solution of the computing device of this embodiment. It should be noted that the technical solution of the computing device belongs to the same concept as the technical solution of the foregoing video-based learning assistance method. For the details that are not further described in the technical solution of the computing device, reference may be made to the description of the technical solution of the foregoing video-based learning assistance method.

An embodiment of the present application further provides a computer-readable storage medium storing computer instructions, where when the computer instructions are executed by a processor, the steps of the video-based learning assistance method described above are implemented.

The foregoing description is a schematic solution of the computer-readable storage medium of this embodiment. It should be noted that the technical solution of the storage medium belongs to the same concept as the technical solution of the foregoing video-based learning assistance method. For the details that are not further described in the technical solution of the storage medium, reference may be made to the description of the technical solution of the foregoing video-based learning assistance method.

Specific embodiments of the present application are described above. Other embodiments are within the scope of the appended claims. In some cases, the actions or steps recited in the claims can be performed in an order different from that in the embodiments, and can still achieve desired results. In addition, the processes depicted in the figures are not necessarily required to be shown in a particular or sequential order, to achieve desired results. In some implementations, multi-task processing and parallel processing are also possible or may be advantageous.

The computer instructions include computer program code, which may be in a source code form, an object code form, an executable file form, some intermediate forms, etc. The computer-readable medium may include: any entity or apparatus that can carry the computer program code, such as a recording medium, a USB flash drive, a removable hard disk, a magnetic disk, an optical disc, a computer memory, a read-only memory (ROM), a random access memory (RAM), an electrical carrier signal, a telecommunications signal, and a software distribution medium. It should be noted that the content included in the computer-readable medium can be appropriately added or deleted depending on requirements of the legislation and patent practice in a jurisdiction. For example, in some jurisdictions, according to the legislation and patent practice, the computer-readable medium does not include an electrical carrier signal and a telecommunications signal.

It should be noted that, for ease of description, the foregoing method embodiments are described as a series of action combinations. However, those skilled in the art should understand that the present application is not limited to the described action order, because according to the present application, some steps may be performed in another order or simultaneously. Moreover, those skilled in the art should also understand that the embodiments described in the specification all are preferred embodiments, and the involved actions and modules are not necessarily required by the present application.

In the foregoing embodiments, the embodiments are described with different emphases, and for a part which is not detailed in an embodiment, reference can be made to the related description of the other embodiments.

The preferred embodiments of the present application disclosed above are merely provided to help illustrate the present application. Optional embodiments are not intended to exhaust all details, nor do they limit the invention to only the described specific implementations. Apparently, many modifications and variations may be made in light of the content of the present application. In the present application, these embodiments are selected and specifically described to provide a better explanation of the principles and actual applications of the present application, so that those skilled in the art can well understand and utilize the present application. The present application should be defined only by the claims, and the full scope and equivalents thereof.

What is claimed is:

1. A method of facilitating video-based language learning, comprising:
determining whether a target video is configured to support a learning mode for learning languages based on detecting an identifier indicative of the learning mode;
displaying a learning mode control in response to determining that the target video is configured to support the learning mode, wherein the learning mode control is a selectable interface element;
receiving a learning instruction via the learning mode control;
splitting into a first display area and a second display area in response to receiving the learning instruction, wherein the first display area is configured to display the target video, and the second display area is configured to display a learning toolbar and learning content corresponding to the target video; and
displaying the learning toolbar and the learning content in the second display area while displaying the target video in the first display area, wherein the learning content is associated with subtitle information corresponding to the target video.

2. The method of claim 1, wherein the learning toolbar comprises a subtitle control, and wherein the method further comprises:
displaying a list of subtitle information corresponding to the target video in response to selecting the subtitle control.

3. The method of claim 2, wherein before the displaying a list of subtitle information corresponding to the target video, the method further comprises:
obtaining audio data of the target video; and
generating the list of subtitle information based at least in part on recognizing the audio data.

4. The method of claim 2, further comprising:
receiving a dragging operation performed on the list of subtitle information;
determining a subtitle to be played with the target video based on the dragging operation;
determining a playback time point of playing the target video based on the subtitle to be played; and
playing the target video from the determined playback time point.

5. The method of claim 1, wherein the learning toolbar comprises a vocabulary control, and the method further comprises:
determining a target subtitle based at least in part on selecting the vocabulary control;
determining a target word in the target subtitle based on predetermined rules;
obtaining preset word information or customized word information associated with the target word; and
displaying the preset word information or the customized word information.

6. The method of claim 5, wherein the determining a target subtitle further comprises:
receiving a vocabulary learning instruction performed on a list of subtitle information displayed in the second display area, and determining the target subtitle based on the vocabulary learning instruction; or
identifying a subtitle included in a current video frame displayed in the first display area as the target subtitle.

7. The method of claim 5, further comprising:
obtaining the preset word information associated with the target word through a third-party dictionary service; or
obtaining the preset word information that is predefined for the target word.

8. The method of claim 5, further comprises:
determining a playback time period of playing the target subtitle in the target video;
determining a bullet-screen time point in the playback time period; and
playing a learning bullet screen associated with the target word at the bullet screen time point, wherein the learning bullet screen is generated based on a learning comment sent by a user, and the learning comment comprises the customized word information associated with the target word.

9. The method of claim 5, further comprising:
receiving a learning comment sending instruction;
presenting an annotation interface in response to receiving the learning comment sending instruction; and
collecting the customized word information associated with the target word via the annotation interface.

10. The method of claim 5, further comprising:
receiving a note-taking instruction for the target word; and
adding the target word to a learning notebook in response to receiving the note-taking instruction.

11. A system, comprising:
at least one processor; and
at least one memory communicatively coupled to the at least one processor and comprising computer-readable instructions that upon execution by the at least one processor cause the at least one processor to perform operations comprising:
determining whether a target video is configured to support a learning mode for learning languages based on detecting an identifier indicative of the learning mode;
displaying a learning mode control in response to determining that the target video is configured to support the learning mode, wherein the learning mode control is a selectable interface element;
receiving a learning instruction via the learning mode control;
splitting into a first display area and a second display area in response to receiving the learning instruction, wherein the first display area is configured to display the target video, and the second display area is configured to display a learning toolbar and learning content corresponding to the target video; and
displaying the learning toolbar and the learning content in the second display area while displaying the target video in the first display area, wherein the learning content is associated with subtitle information corresponding to the target video.

12. The system of claim 11, wherein the learning toolbar comprises a subtitle control, and wherein the operations further comprise:
displaying a list of subtitle information corresponding to the target video in response to selecting the subtitle control.

13. The system of claim 12, the operations further comprising:
receiving a dragging operation performed on the list of subtitle information;
determining a subtitle to be played with the target video based on the dragging operation;
determining a playback time point of playing the target video based on the subtitle to be played; and
playing the target video from the determined playback time point.

14. The system of claim 11, wherein the learning toolbar comprises a vocabulary control, and the operations further comprise:
determining a target subtitle based at least in part on selecting the vocabulary control;
determining a target word in the target subtitle based on predetermined rules;
obtaining preset word information or customized word information associated with the target word; and
displaying the preset word information or the customized word information.

15. The system of claim 14, the operations further comprising:
obtaining the preset word information associated with the target word through a third-party dictionary service; or
obtaining the preset word information that is predefined for the target word.

16. The system of claim 14, the operations further comprises:
determining a playback time period of playing the target subtitle in the target video;
determining a bullet-screen time point in the playback time period; and
playing a learning bullet screen associated with the target word at the bullet-screen time point, wherein the learning bullet screen is generated based on a learning comment sent by a user, and the learning comment comprises the customized word information associated with the target word.

17. The system of claim 14, the operations further comprising:
receiving a learning comment sending instruction;
presenting an annotation interface in response to receiving the learning comment sending instruction; and
collecting the customized word information associated with the target word via the annotation interface.

18. A non-transitory computer-readable storage medium, storing computer-readable instructions that upon execution by a processor cause the processor to implement operations comprising:
determining whether a target video is configured to support a learning mode for learning languages based on detecting an identifier indicative of the learning mode;
displaying a learning mode control in response to determining that the target video is configured to support the learning mode, wherein the learning mode control is a selectable interface element;
receiving a learning instruction via the learning mode control;
splitting into a first display area and a second display area in response to receiving the learning instruction, wherein the first display area is configured to display the target video, and the second display area is configured to display a learning toolbar and learning content corresponding to the target video; and
displaying the learning toolbar and the learning content in the second display area while displaying the target video in the first display area, wherein the learning content is associated with subtitle information corresponding to the target video.

19. The non-transitory computer-readable storage medium of claim 18, wherein the learning toolbar comprises a subtitle control, and wherein the operations further comprise:
displaying a list of subtitle information corresponding to the target video in response to selecting the subtitle control;
receiving a dragging operation performed on the list of subtitle information;
determining a subtitle to be played with the target video based on the dragging operation;
determining a playback time point of playing the target video based on the subtitle to be played; and
playing the target video from the determined playback time point.

20. The non-transitory computer-readable storage medium of claim 18, wherein the learning toolbar comprises a vocabulary control, and the operations further comprise:
determining a target subtitle based at least in part on selecting the vocabulary control;
determining a target word in the target subtitle based on predetermined rules;
obtaining preset word information or customized word information associated with the target word; and
displaying the preset word information or the customized word information.
